(19) United States
(12) Patent Application Publication
(10) Pub. No.: US 2021/0261706 A1
(43) Pub. Date: Aug. 26, 2021

(54) RESIN COMPOSITION, HEAT STORAGE MATERIAL, AND ARTICLE

(71) Applicant: Showa Denko Materials Co., Ltd., Tokyo (JP)

(72) Inventors: Naoki FURUKAWA, Chiyoda-ku, Tokyo (JP); Tsuyoshi MORIMOTO, Chiyoda-ku, Tokyo (JP); Akira NAGAI, Chiyoda-ku, Tokyo (JP); Nozomi MATSUBARA, Chiyoda-ku, Tokyo (JP)

(73) Assignee: Showa Denko Materials Co., Ltd., Tokyo (JP)

(21) Appl. No.: 17/261,571

(22) PCT Filed: Jun. 27, 2019
(86) PCT No.: PCT/JP2019/025735

§ 371 Date: Jan. 20, 2021

(30) Foreign Application Priority Data
Jul. 26, 2018 (JP) 2018-140168

(51) Int. Cl. C08F 220/16; C09K 5/06; F28F 21/06

(52) U.S. Cl. CPC C08F 220/16; C08F 2800/20; F28F 21/065; C09K 5/063

(57) ABSTRACT

An aspect of the present invention provides a resin composition containing an acrylic resin which is obtained by polymerizing a monomer component including: a first monomer represented by formula (1); and a second monomer which is copolymerizable with the first monomer and has a block isocyanate group.

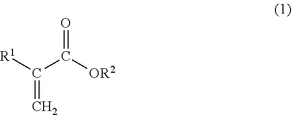

(In the formula, R¹ represents a hydrogen atom or a methyl group, and R² represents an alkyl group having 12-30 carbon atoms.)

### TECHNICAL FIELD

The present invention relates to a resin composition, a heat storage material, and an article.

### BACKGROUND ART

Heat storage materials are materials that can take out stored energy as heat as necessary. These heat storage materials are used for applications such as air conditioning instruments, floor heating devices, refrigerators, electronic components such as an IC chip, interior and exterior materials for automobiles, automobile parts such as canisters, insulating containers, and the like.

Regarding a heat storage method, latent heat storage utilizing a phase change of a substance is widely used in consideration of amount of heat. Water-ice is a well-known latent heat storage substance. Water-ice is a substance having a large amount of heat, but its application range is limited because the phase change temperature is limited to 0° C. in the atmosphere. Therefore, paraffin is used as a latent heat storage substance having a phase change temperature of higher than 0° C. and 100° C. or lower. However, paraffin becomes a liquid when it undergoes a phase change due to heating, and there is a risk of ignition and combustion. Therefore, in order to use paraffin as a heat storage material, it is necessary to prevent paraffin from leaking from the heat storage material by storing it in a sealed container such as a bag and its fields of application are limited.

Regarding a method of improving a heat storage material containing paraffin, for example, Patent Literature 1 discloses a method using a gelling agent. The gel produced by this method can maintain a gel-like molded product even after the phase of paraffin changes. However, in this method, liquid leakage, volatilization of the heat storage material, and the like may occur when used as a heat storage material.

In addition, as another improvement method, for example, Patent Literature 2 discloses a method using a hydrogenated conjugated diene copolymer. In this method, the form can be maintained near a melting or solidification temperature of a hydrocarbon compound, but when the temperature becomes higher, phase separation occurs due to low compatibility, and liquid leakage of the hydrocarbon compound occurs.

In addition, as still another improvement method, for example, Patent Literature 3 discloses a method of microencapsulating a heat storage material. In this method, since the heat storage material is encapsulated, handling properties are favorable regardless of the phase change, but there is a concern of the heat storage material leaking from the capsule in a high temperature range.

### CITATION LIST

### Patent Literature

### Patent Literature 1

Japanese Patent Laid-Open No. 2000-109787

### Patent Literature 2

Japanese Patent Laid-Open No. 2014-95023

### Patent Literature 3

Japanese Patent Laid-Open No. 2005-23229

### SUMMARY

### Technical Problem

An objective of one aspect of the present invention is to provide a resin composition suitably used as a heat storage material. An objective of another aspect of the present invention is to provide a heat storage material having an excellent amount of heat storage.

### Solution to Problem

The inventors conducted extensive studies, and as a result, found that a resin composition including specific components is suitably used as a heat storage material, that is, the inventors found that a heat storage material formed of the resin composition has an excellent amount of heat storage, and completed the present invention. Some aspects of the present invention provide the following [1] to [12].

[1] A resin composition containing an acrylic resin obtained by polymerizing a monomer component including a first monomer represented by the following Formula (1) and a second monomer copolymerizable with the first monomer and having a block isocyanate group:

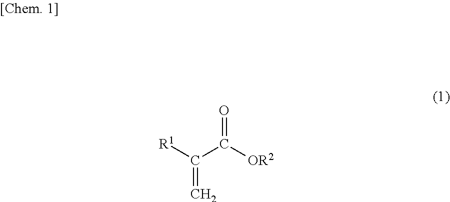

[in the formula, R¹ represents a hydrogen atom or a methyl group and R² represents an alkyl group having 12 to 30 carbon atoms]
[2] A resin composition containing an acrylic resin including a first structural unit represented by the following Formula (2) and a second structural unit having a block isocyanate group:

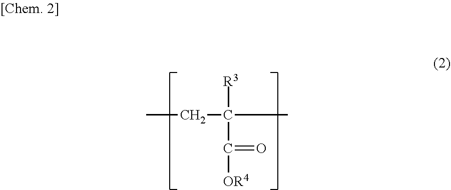

[in the formula, R³ represents a hydrogen atom or a methyl group, and R⁴ represents an alkyl group having 12 to 30 carbon atoms]
[3] The resin composition according to [1] or [2], further including a curing agent capable of reacting with the block isocyanate group under deprotection conditions of the block isocyanate group.
[4] The resin composition according to [3], wherein the curing agent is at least one compound selected from the group consisting of an amine compound and an alcohol compound.
[5] The resin composition according to [1], wherein a content of the first monomer is 60 parts by mass or more with respect to 100 parts by mass of the monomer components.
[6] The resin composition according to [1] or [5], wherein a content of the second monomer is 25 parts by mass or less with respect to 100 parts by mass of the monomer components.
[7] The resin composition according to [2], wherein a content of the first structural unit is 60 parts by mass or more with respect to 100 parts by mass of all structural units constituting the acrylic resin.
[8] The resin composition according to [2] or [7], wherein a content of the second structural unit is 25 parts by mass or less with respect to 100 parts by mass of all structural units constituting the acrylic resin.
[9] The resin composition according to any one of [1] to [8], wherein a content of the acrylic resin is 50 parts by mass or more with respect to 100 parts by mass of the resin composition.
[10] The resin composition according to any one of [1] to [9], wherein the resin composition is used to form a heat storage material.
[11] A heat storage material including a cured product of the resin composition according to any one of [1] to [10].
[12] An article, including: a heat source; and a cured product of the resin composition according to any one of [1] to [10], the cured product provided to be in thermal contact with the heat source.

### Advantageous Effects of Invention

According to one aspect of the present invention, it is possible to provide a resin composition suitably used as a heat storage material. In addition, a resin composition according to one aspect of the present invention has excellent reactivity when reacting with a curing agent and has fast curability. According to a resin composition according to one aspect of the present invention, the acrylic resin can be cured, for example, within 1 hour, more preferably within 30 minutes, and still more preferably within 1 minute. The resin composition according to one aspect of the present invention has excellent storage stability, and can prevent gelation due to the progress of a curing reaction of the resin composition, for example, in a high temperature and high humidity environment.

According to another aspect of the present invention, it is possible to provide a heat storage material having an excellent amount of heat storage. In addition, the heat storage material according to one aspect of the present invention can minimize liquid leakage at a phase change temperature or higher of the heat storage material and also has excellent heat resistance.

### BRIEF DESCRIPTION OF DRAWINGS

FIG. 1 is a schematic cross-sectional view showing one embodiment of an article including a heat storage material.

### DESCRIPTION OF EMBODIMENTS

Embodiments of the present invention will be appropriately described below with reference to the drawings. Here, the present invention is not limited to the following embodiments.

In this specification, “(meth)acrylate” means “acrylate” and a corresponding “methacrylate” and “(meth)acryloyl” means “acryloyl” and a corresponding “methacroyl.”

The weight average molecular weight (Mw) and number average molecular weight (Mn) in this specification were measured by gel permeation chromatography (GPC) under the following conditions and mean values determined using polystyrene as a standard substance.
Measuring instrument: HLC-8320GPC (product name, commercially available from Tosoh Corporation)
Analytical column: TSK gel SuperMultipore HZ-H (3 columns connected) (product name, commercially available from Tosoh Corporation)
Guard column: TSK guardcolumn SuperMP(HZ)-H (product name, commercially available from Tosoh Corporation)
Eluent: THF
Measurement temperature: 25° C.

In this specification, “heat resistance is excellent” means that the 1% weight loss temperature in TG-DTA measurement is 280° C. or higher.

A resin composition according to one embodiment contains an acrylic resin. The acrylic resin is a polymer obtained by polymerizing a monomer component including a first monomer and a second monomer.

The first monomer is represented by the following Formula (1).

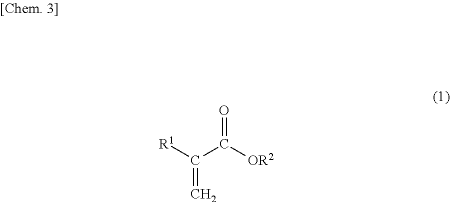

In the formula, R¹ represents a hydrogen atom or a methyl group, and R² represents an alkyl group having 12 to 30 carbon atoms.

The alkyl group represented by R² may be linear or branched. The number of carbon atoms of the alkyl group represented by R² is preferably 12 to 28, more preferably 12 to 26, still more preferably 12 to 24, and particularly preferably 12 to 22.

In other words, the first monomer is an alkyl (meth)acrylate having a linear or branched alkyl group having 12 to 30 carbon atoms at the end of the ester group. Examples of first monomers include dodecyl (meth)acrylate (lauryl (meth)acrylate), tetradecyl (meth)acrylate, hexadecyl (meth)acrylate, octadecyl (meth)acrylate (stearyl (meth)acrylate), docosyl (meth)acrylate (behenyl (meth)acrylate), tetracosyl (meth)acrylate, hexacosyl (meth)acrylate, and octacosyl (meth)acrylate. These first monomers may be used alone or two or more thereof may be used in combination. The first monomer is preferably at least one selected from the group consisting of a dodecyl (meth)acrylate (lauryl (meth)acrylate), hexadecyl (meth)acrylate, octadecyl (meth)acrylate (stearyl (meth)acrylate), and docosyl (meth)acrylate (behenyl (meth)acrylate).

In order to obtain a sufficient amount of heat storage when the heat storage material is formed, the content of the first monomer is preferably 60 parts by mass or more, more preferably 70 parts by mass or more, and still more preferably 80 parts by mass or more, and may be, for example, 98 parts by mass or less, with respect to 100 parts by mass of the monomer components.

The second monomer is a monomer having a block isocyanate group. The block isocyanate group is an isocyanate group blocked (protected) by a blocking agent (protecting group) that can be desorbed by heat, and is represented by the following Formula (3):

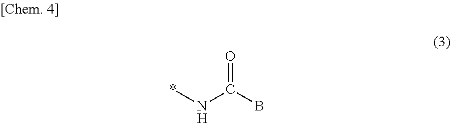

In the formula, B represents a protecting group, and *represents a bond.

The protecting group in the block isocyanate group may be a protecting group that can be desorbed (deprotected) by heat (for example, heating at 80 to 160° C.). In the block isocyanate group, under deprotection conditions (for example, under heating conditions at 80 to 160° C.), a substitution reaction between a blocking agent (protecting group) and a curing agent to be described below may occur. Alternatively, in the block isocyanate group, an isocyanate group is generated by deprotection, and the isocyanate group can also react with the curing agent to be described below.

Examples of blocking agents for block isocyanate groups include oximes such as formaldoxime, acetaldoxime, acetoxime, methylethylketooxime, and cyclohexanone oxime; pyrazoles such as pyrazole, 3-methylpyrazole, and 3,5-dimethylpyrazole; lactams such as ç-caprolactam, δ-valerolactam, γ-butyrolactam, and β-propiolactam; mercaptans such as thiophenol, methyl thiophenol, and ethyl thiophenol; acid amides such as acetic acid amide and benzamide; and imides such as imide succinate and imide maleate.

The second monomer is preferably a monomer having a block isocyanate group and a (meth)acryloyl group (a (meth)acrylic monomer having a block isocyanate group). The second monomer is preferably a monomer represented by the following Formula (4).

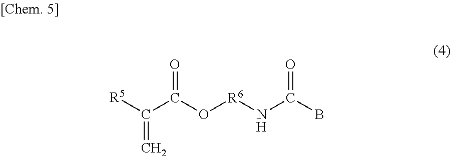

In the formula, R⁵ represents a hydrogen atom or a methyl group, R⁶ represents an alkylene group, and B represents a protecting group.

The alkylene group represented by R⁶ may be linear or branched. The number of carbon atoms of the alkylene group represented by R⁶ may be, for example, 1 to 10, 1 to 8, 1 to 6, 1 to 4, or 1 to 2.

Examples of second monomers include 2-[(3,5-dimethylpyrazolyl)carbonylamino]ethyl methacrylate, and 2-(0-[1′-methylpropylideneamino]carboxyamino) methacrylate. These second monomers may be used alone or two or more thereof may be used in combination.

When the weight average molecular weight (details will be described below) of the acrylic resin is 200,000 or more, in order to obtain better heat resistance of the heat storage material, the content of the second monomer is preferably 2 parts by mass or more, more preferably 3 parts by mass or more, still more preferably 5 parts by mass or more, and particularly preferably 7 parts by mass or more with respect to 100 parts by mass of the monomer components.

When the weight average molecular weight (details will be described below) of the acrylic resin is 100,000 or less, in order to obtain excellent curability of the resin composition, the content of the second monomer is preferably 2 parts by mass or more, more preferably 3 parts by mass or more, still more preferably 5 parts by mass or more, and particularly preferably 7 parts by mass or more with respect to 100 parts by mass of the monomer components.

In order to obtain an excellent amount of heat storage of the heat storage material regardless of the weight average molecular weight of the acrylic resin (details will be described below), the content of the second monomer may be 2 parts by mass or more, 3 parts by mass or more, 5 parts by mass or more, or 7 parts by mass or more, and may be 25 parts by mass or less, and is preferably 20 parts by mass or less, more preferably 15 parts by mass or less, still more preferably 13 parts by mass or less, and particularly preferably 10 parts by mass or less with respect to 100 parts by mass of the monomer components.

The monomer component may further include other monomers (a third monomer), as necessary, in addition to the first monomer and the second monomer. Examples of other monomers include alkyl (meth)acrylates having an alkyl group having less than 12 carbon atoms (1 to 11 carbon atoms) at the end of the ester group such as methyl (meth)acrylate, ethyl (meth)acrylate, propyl (meth)acrylate, and butyl (meth)acrylate; and a cycloalkyl (meth)acrylate having a cyclic hydrocarbon group at the end of the ester group such as isobornyl (meth)acrylate and dicyclopentanyl (meth)acrylate. The third monomers may be used alone or two or more thereof may be used in combination.

In one embodiment, the monomer component includes only the first monomer and the second monomer, and as necessary, at least one third monomer selected from the group consisting of an alkyl (meth)acrylate having an alkyl group having 1 to 11 carbon atoms at the end of the ester group and a cycloalkyl (meth)acrylate having a cyclic hydrocarbon group at the end of the ester group. In other words, in one embodiment, the monomer component does not include any monomer other than the first monomer, the second monomer and the third monomer (for example, a (meth)acrylic monomer having a siloxane framework). In one embodiment, the monomer component may include only the first monomer and the second monomer, and in another embodiment, the monomer component may include only the first monomer, the second monomer, and the third monomer.

In one embodiment, the monomer component does not include any monomer other than the first monomer, the second monomer and the third monomer (for example, a (meth)acrylic monomer having a siloxane framework). In one embodiment, the monomer component may include only the first monomer and the second monomer, and in another embodiment, the monomer component may include only the first monomer, the second monomer, and the third monomer.

The acrylic resin is obtained by polymerizing a monomer component including the first monomer, the second monomer, and other monomers used as necessary. The polymerization method can be appropriately selected from among known polymerization methods such as various radical polymerizations, and examples thereof include a suspension polymerization method, a solution polymerization method, and a bulk polymerization method. Regarding the polymerization method, when the weight average molecular weight of the acrylic resin is large (for example, 200,000 or more), a suspension polymerization method is preferably used, and when the weight average molecular weight of the acrylic resin is small (for example, 100,000 or less), a solution polymerization method is preferably used.

When the suspension polymerization method is used, monomer components that are raw materials, a polymerization initiator, a chain transfer agent that is added as necessary, water and a suspension aid are mixed to prepare a dispersion solution.

Examples of suspension aids include water-soluble polymers such as polyvinyl alcohol, methyl cellulose, and polyacrylamide, and sparingly soluble inorganic substances such as calcium phosphate and magnesium pyrophosphate. Among these, a water-soluble polymer such as polyvinyl alcohol is preferably used.

The amount of the suspension aid added is preferably 0.005 to 1 part by mass and more preferably 0.01 to 0.07 parts by mass with respect to 100 parts by mass of a total amount of the monomer components that are raw materials. When the suspension polymerization method is used, a molecular weight adjusting agent such as a mercaptan compound, thioglycol, carbon tetrachloride, and an α-methylstyrene dimer may be additionally added as necessary. The polymerization temperature is preferably 0 to 200° C., more preferably 40 to 120° C., and still more preferably 50 to 100° C.

When the solution polymerization method is used, examples of solvents to be used include aromatic solvents such as toluene and xylene, ketone solvents such as methyl ethyl ketone and methyl isobutyl ketone, ester solvents such as ethyl acetate and butyl acetate, chlorine solvents such as carbon tetrachloride, and alcoholic solvents such as 2-propanol and 2-butanol. In consideration of the polymerizability of the obtained acrylic resin, the solid content concentration in the solution when solution polymerization starts is preferably 30 to 80 mass %, more preferably 40 to 70 mass %, and still more preferably 50 to 60 mass %. The polymerization temperature is preferably 0 to 200° C., more preferably 40 to 120° C., and still more preferably 50 to 100° C.

The polymerization initiator used in each polymerization method can be used without particular limitation as long as it is a radical polymerization initiator. Examples of radical polymerization initiators include organic peroxides such as benzoyl peroxide, lauroyl peroxide, di-t-butylperoxyhexahydroterephthalate, t-butylperoxy-2-ethylhexanoate, 1,1-t-butylperoxy-3,3,5-trimethylcyclohexane, and t-butyl peroxyisopropyl carbonate, and azo compounds such as azobisisobutyronitrile, azobis-4-methoxy-2,4-dimethylvaleronitrile, azobiscyclohexanone-1-carbonitrile, and azodibenzoyl.

In order to sufficiently polymerize monomers, the amount of the polymerization initiator added is preferably 0.01 parts by mass or more, more preferably 0.05 parts by mass or more, and still more preferably 0.1 parts by mass or more with respect to 100 parts by mass of a total amount of the monomers. In order to set the molecular weight of the acrylic resin to be in a suitable range, reduce the amount of a decomposition product, and obtain suitable adhesive strength when used as a heat storage material, the amount of the polymerization initiator added is preferably 10 parts by mass or less, more preferably 5 parts by mass or less, and still more preferably 3 parts by mass or les with respect to 100 parts by mass of a total amount of the monomers.

The acrylic resin obtained as described above includes a structural unit derived from the first monomer and a structural unit derived from the second monomer. That is, the resin composition according to one embodiment includes an acrylic resin including a first structural unit (structural unit derived from the first monomer) and a second structural unit (structural unit derived from the second monomer).

The first structural unit is represented by the following Formula (2).

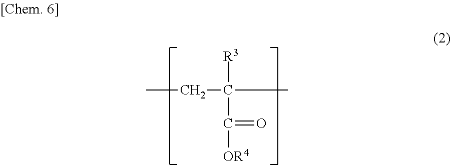

In the formula, R³ represents a hydrogen atom or a methyl group, and R⁴ represents an alkyl group having 12 to 30 carbon atoms.

The alkyl group represented by R⁴ may be linear or branched. The number of carbon atoms of the alkyl group represented by R⁴ is preferably 12 to 28, more preferably 12 to 26, still more preferably 12 to 24, and particularly preferably 12 to 22. Examples of alkyl groups represented by R⁴ include a dodecyl group (lauryl group), a tetradecyl group, a hexadecyl group, an octadecyl group (stearyl group), a docosyl group (behenyl group), a tetracosyl group, a hexacosyl group, and an octacosyl group. The alkyl group represented by R⁴ is preferably at least one selected from the group consisting of a dodecyl group (lauryl group), a hexadecyl group, an octadecyl group (stearyl group), and a docosyl group (behenyl group). The acrylic resin includes one or more of these first structural units.

In order to obtain an excellent amount of heat storage of the heat storage material, the content of the first structural unit is preferably 60 parts by mass or more, more preferably 70 parts by mass or more, and still more preferably 80 parts by mass or more, and may be, for example, 98 parts by mass or less, with respect to 100 parts by mass of all structural units constituting the acrylic resin.

The second structural unit has a block isocyanate group. The second structural unit is, for example, a structural unit derived from a monomer having the above blocking group.

The second structural unit is preferably a structural unit represented by the following Formula (5).

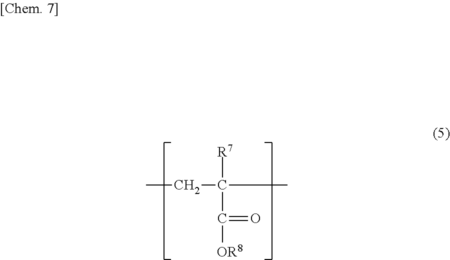

In the formula, R⁷ represents a hydrogen atom or a methyl group, and R⁸ represents a monovalent organic group having a block isocyanate group. The block isocyanate group may be a group having the same block isocyanate group included in the above second monomer.

The second structural unit is preferably represented by the following Formula (6).

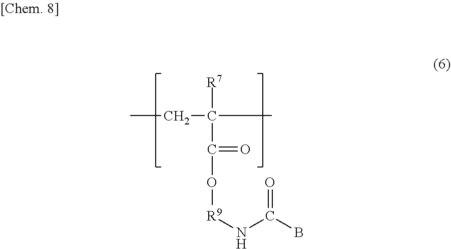

In the formula, R⁷ represents a hydrogen atom or a methyl group, R⁹ represents an alkylene group, and B represents a protecting group.

The alkylene group represented by R⁹ may be linear or branched. The number of carbon atoms of the alkylene group represented by R⁹ may be, for example, 1 to 10, 1 to 8, 1 to 6, 1 to 4, or 1 to 2.

When the weight average molecular weight (details will be described below) of the acrylic resin is 200,000 or more, in order to obtain better heat resistance of the heat storage material, the content of the second structural unit is preferably 2 parts by mass or more, more preferably 3 parts by mass or more, still more preferably 5 parts by mass or more, and particularly preferably 7 parts by mass or more with respect to 100 parts by mass of all structural units constituting the acrylic resin.

When the weight average molecular weight (details will be described below) of the acrylic resin is 100,000 or less, in order to obtain excellent curability of the resin composition, the content of the second structural unit is preferably 2 parts by mass or more, more preferably 3 parts by mass or more, still more preferably 5 parts by mass or more, and particularly preferably 7 parts by mass or more with respect to 100 parts by mass of all structural units constituting the acrylic resin.

In order to obtain a sufficient amount of heat storage when the heat storage material is formed regardless of the weight average molecular weight of the acrylic resin (details will be described below), the content of the second structural unit may be 2 parts by mass or more, 3 parts by mass or more, 5 parts by mass or more, or 7 parts by mass or more, and may be 25 parts by mass or less, and is preferably 20 parts by mass or less, more preferably 15 parts by mass or less, still more preferably 13 parts by mass or less, and particularly preferably 10 parts by mass or less with respect to 100 parts by mass of all structural units constituting the acrylic resin.

The acrylic resin may further include other structural units as necessary in addition to the first structural unit and the second structural unit. Other structural units may be structural units derived from the above other monomers.

In one embodiment, the acrylic resin includes only the first structural unit and the second structural unit, and as necessary, a third structural unit derived from at least one monomer selected from the group consisting of an alkyl (meth)acrylate having an alkyl group having 1 to 11 carbon atoms at the end of the ester group and a cycloalkyl (meth)acrylate having a cyclic hydrocarbon group at the end of the ester group. In other words, in one embodiment, the acrylic resin does not include any structural unit other than the first structural unit, the second structural unit, and the third structural unit (for example, a structural unit derived from a (meth)acrylic monomer having a siloxane framework). In one embodiment, the acrylic resin may include only the first structural unit and the second structural unit, and in another embodiment, the acrylic resin may include only the first structural unit, the second structural unit, and the third structural unit.

The acrylic resin may be any of a random copolymer, a block copolymer and a graft copolymer.

In one embodiment, in order to obtain an excellent strength of the heat storage material, the weight average molecular weight of the acrylic resin is preferably 200,000 or more, more preferably 250,000 or more, and still more preferably 300,000 or more. In consideration of ease of handling of the resin composition, the weight average molecular weight of the acrylic resin is preferably 2,000,000 or less, more preferably 1,500,000 or less, and still more preferably 1,000,000 or less.

In another embodiment, in order to reduce the viscosity of the resin composition, the weight average molecular weight of the acrylic resin is preferably 100,000 or less, more preferably 70,000 or less, and still more preferably 50,000 or less. In this case, the weight average molecular weight of the acrylic resin may be, for example, 5,000 or more.

In order to obtain an excellent amount of heat storage of the heat storage material, the content of the acrylic resin is preferably 50 parts by mass or more, more preferably 70 parts by mass or more, and still more preferably 80 parts by mass or more with respect to 100 parts by mass of the resin composition. The content of the acrylic resin may be 100 parts by mass or less, 99.5 parts by mass or less, or 99.0 parts by mass or less with respect to 100 parts by mass of the resin composition.

The resin composition may further include a curing agent in order to minimize liquid leakage and volatilization of a heat storage material and improve the heat resistance when used to form the heat storage material. The curing agent can react with a block isocyanate group under deprotection conditions (for example, under heating conditions at 80 to 160° C.) for the block isocyanate group contained in the second monomer (second structural unit). More specifically, the curing agent is a curing agent that can perform a substitution reaction with a blocking agent (protecting group) under deprotection conditions with respect to a block isocyanate group contained in the second monomer (second structural unit). Alternatively, the curing agent is a curing agent that can react with an isocyanate group generated when the blocking agent is desorbed (deprotected) in the block isocyanate group contained in the second monomer (second structural unit).

The curing agent is preferably at least one compound selected from the group consisting of an amine compound and an alcohol compound in order to increase the reactivity between the acrylic resin and the curing agent and increase the curing speed. The curing agent may have a function of crosslinking the acrylic resins with each other, and may also be called a crosslinking agent.

Examples of amine compounds include aromatic amines such as diaminodiphenylmethane, diaminodiphenylsulphon, diaminodiphenyl ether, p-phenylenediamine, m-phenylenediamine, o-phenylenediamine, 1,5-diaminonaphthalene, and m-xylylenediamine, aliphatic amines such as ethylenediamine, diethylenediamine, diethylenetriamine, hexamethylenediamine, isophorone diamine, bis(4-amino-3-methyldicyclohexyl)methane, and polyether diamine, and guanidines such as diocyandiamide and 1-(o-tolyl)biguanide.

Examples of alcohol compounds include multivalent alcohols such as glycerin, 1,4-butanediol, 1,6-hexanediol, 1,9-nonanediol, and diethylene glycol.

The content of the curing agent is preferably 0.01 parts by mass or more, more preferably 10 parts by mass or less, still more preferably 5 parts by mass or less, and yet more preferably 1 part by mass or less with respect to 100 parts by mass of the resin composition.

The resin composition may further contain other additives as necessary. Examples of other additives include a curing accelerator, an antioxidant, a coloring agent, a filler, a crystal nucleating agent, a heat stabilizer, a thermal conductive material, a plasticizer, a foaming agent, a flame retardant, and a damping agent. Other additives may be used alone or two or more thereof may be used in combination.

The resin composition preferably further contains a curing accelerator in order to promote the reaction between the acrylic resin and the curing agent. Examples of curing accelerators include an imidazole curing accelerator, an organophosphorus curing accelerator, a tertiary amine curing accelerator, a quaternary ammonium salt curing accelerator, and a tin catalyst. Among these, a tin catalyst such as dibutyltin dilaurate is preferable. These curing accelerators may be used alone or two or more thereof may be used in combination.

The content of the curing accelerator is preferably 0.005 parts by mass or more, more preferably 0.01 parts by mass or more, and still more preferably 0.02 parts by mass or more, and preferably 1 part by mass or less, more preferably 0.5 parts by mass or less, and still more preferably 0.2 parts by mass or less with respect to 100 parts by mass of the resin composition.

The resin composition may be a solid or a liquid at 90° C., and is preferably a liquid because it is easily filled into a member having a complicated shape, and an application range of a heat storage material is widened.

In order to obtain excellent fluidity and handling properties, the viscosity of the resin composition at 90° C. is preferably 100 Pa·s or less, more preferably 50 Pa·s or less, still more preferably 20 Pa·s or less, and particularly preferably 10 Pa·s or less. For the same reason, the viscosity of the resin composition is, at the melting point of the acrylic resin+20° C., preferably 100 Pa·s or less, more preferably 50 Pa·s or less, still more preferably 20 Pa·s or less, and particularly preferably 10 Pa·s or less. The viscosity of the resin composition at 90° C. or the viscosity at the melting point of the acrylic resin+20° C. may be, for example, 0.5 Pa·s or more.

The viscosity of the resin composition means a value measured based on JIS Z 8803, and specifically, means a value measured by an E type viscosmeter (commercially available from Toki Sangyo Co., Ltd., PE-80L). Here, the viscometer can be calibrated based on JIS Z 8809-JS14000. In addition, the melting point of the acrylic resin means a value measured by the method described in examples.

The resin composition described above is suitably used as a heat storage material by curing the resin composition (suitable as a resin composition for a heat storage material). That is, the heat storage material according to one embodiment includes a cured product of the above resin composition. In the heat storage material, a cured product of the acrylic resin functions as a component having a heat storage property. Therefore, in one embodiment, for example, the heat storage material does not include a heat storage capsule containing a latent heat storage material used in the conventional heat storage material, and in this case also, an excellent amount of heat storage is obtained.

In addition, since the heat storage material according to one embodiment contains the above acrylic resin, it has excellent storage stability before curing, and a cured product can be rapidly obtained when used as a heat storage material.

The heat storage material (a cured product of the above resin composition) can be used in various fields. The heat storage material is used for, for example, air conditioning instruments (improving efficiency of air conditioning instruments) in automobiles, buildings, public facilities, underground shopping centers, and the like, pipes (heat storage of pipes) in factories and the like, automobile engines (heat retention around the engines), electronic components (prevention of temperature rise of electronic components), and fibers for underwear.

In each of these applications, the heat storage material (a cured product of the above resin composition) is arranged in thermal contact with a heat source that generates heat in each application, and thus can store heat of the heat source. That is, one embodiment of the present invention is an article including a heat source and a heat storage material (a cured product of the above resin composition) that is provided so that it is in thermal contact with the heat source.

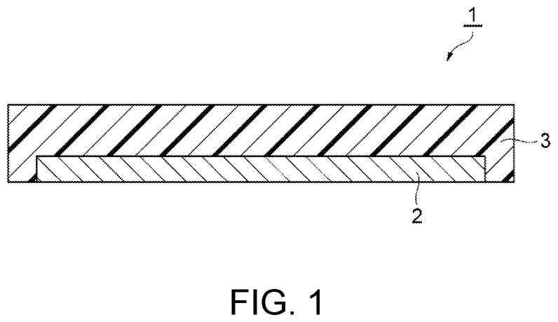

FIG. 1 is a schematic cross-sectional view showing one embodiment of an article including a heat storage material. As shown in FIG. 1, an article 1 includes a heat source 2 and a heat storage material 3 that is provided so that it is in thermal contact with the heat source 2. The heat storage material 3 may be arranged in thermal contact with at least a part of the heat source 2, and as shown in FIG. 1, or may be arranged so that a part of the heat source 2 is exposed or the entire surface of the heat source 2 is covered. If the heat storage material 3 is in thermal contact with the heat source 2, the heat source 2 and the heat storage material 3 may be in direct contact with each other, and another member (for example, a member having thermal conductivity) may be arranged between the heat source 2 and the heat storage material 3.

For example, when the heat storage material 3 is used together with an air conditioning instrument (or a part thereof), a pipe, or an automobile engine as the heat source 2, the heat storage material 3 is in thermal contact with these heat sources 2, the heat storage material 3 stores heat generated from the heat source 2, and the heat source 2 is easily maintained at a certain temperature or higher (heat is retained). When the heat storage material 3 is used as fibers for underwear, since the heat storage material 3 stores heat generated from the human body as the heat source 2, warmth can be felt for a long time.

For example, if the heat storage material 3 is used together with the electronic component as the heat source 2, when it is arranged in thermal contact with the electronic component, it is possible to store heat generated in the electronic component. In this case, for example, when the heat storage material is arranged in additional thermal contact with the heat dissipation member, heat stored in the heat storage material can be gradually released, and it is possible to prevent heat generated in the electronic component from being released rapidly to the outside (and the vicinity of the electronic component from becoming locally hot).

The heat storage material 3 may be arranged in the heat source 2 after a cured product is formed in a sheet form (film form). When the resin composition is a solid at 90° C., the sheet-like heat storage material 3 is obtained by, for example, heating, melting, and molding the resin composition. That is, in one embodiment, a method of producing the heat storage material 3 includes a step of heating, melting, and molding a resin composition (molding step). Molding in the molding step may be injection molding, compression molding or transfer molding. In this case, the heat storage material 3 does not require a casing, and the heat storage material 3 alone can be adhered to an attachment target, wound therearound, and attached in various states.

In another embodiment, a cured product of the above resin composition can also be used for applications other than the heat storage material. The cured product is suitably used to form, for example, a water-repellent material, an anti-frost material, a refractive index adjusting material, a lubricant, an adsorbent, a thermosetting stress relaxation material or a low dielectric material. The water-repellent material, the anti-frost material, the refractive index adjusting material, the lubricant, the adsorbent, the thermosetting stress relaxation material and the low dielectric material each may contain, for example, a cured product of the above resin composition.

### EXAMPLES

While the present invention will be described below in more detail with reference to examples, the present invention is not limited to the following examples.

### [Synthesis of Acrylic Resin]

Acrylic resins 1A to 1F used in Examples 1-1 to 1-8 were synthesized by a known suspension polymerization method as follows.

### Synthesis Example of Acrylic Resin 1A

A 500 mL flask composed of a stirrer, a thermometer, a nitrogen gas introduction pipe, a discharge pipe and a heating jacket was used as a reaction container, and nitrogen was flowed in the flask at 100 mL/min.

Next, 80 g of tetradecyl acrylate, 10 g of butyl acrylate, and 10 g of 2-[(3,5-dimethylpyrazolyl)carbonylamino]ethyl methacrylate as monomers were mixed, and 0.41 g of lauroyl peroxide as a polymerization initiator, and 0.12 g of n-octyl mercaptan as a chain transfer agent were additionally added and dissolved to obtain a mixture. Then, 201.3 g of water (200 parts by mass with respect to 100 parts by mass of the mixture), and 0.2 g of polyvinyl alcohol (PVA) (0.02 parts by mass with respect to 100 parts by mass of the mixture) as a suspension aid were added to the mixture to prepare a dispersion solution.

Subsequently, the dispersion solution was supplied into the flask (reaction container) in which nitrogen was flowed to reduce dissolved oxygen to 1 ppm or less, and heating as performed while stirring at a temperature inside the reaction container of 60° C. and a stirring rotational speed of 250 times/min, and the reaction was performed for 4 hours. A polymerization rate was calculated from a specific gravity of the resin produced while sampling during the reaction, and the polymerization rate of 80% or more was confirmed, and then the temperature raised to 90° C., and the reaction was additionally performed for 2 hours. Then, the product in the reaction container was cooled, the product was taken out, washed with water, dehydrated, and dried to obtain an acrylic resin 1A. The weight average molecular weight (Mw) of the acrylic resin 1A was 700,000.

Acrylic resins 1B to 1F were synthesized in the same method as in the synthesis example of the acrylic resin 1A except that monomer components were changed to monomer components shown in Table 1. Table 1 also shows the weight average molecular weight (Mw) of the obtained acrylic resins.

TABLE 1

| | | Acrylic resin | | | | | |
|---|---|---|---|---|---|---|---|
| | | 1A | 1B | 1C | 1D | 1E | 1F |
| Monomer | Lauryl acrylate | — | 93 | — | — | — | — |
| component | Tetradecyl acrylate | 80 | — | 93 | — | — | 80 |
| (parts by | Stearyl acrylate | — | — | — | 93 | — | — |
| mass) | Behenyl acrylate | — | — | — | — | 93 | — |
| | 2-[(3,5-Dimethylpyrazolyl)- | 10 | 7 | 7 | 7 | 7 | — |
| | carbonylamino]ethyl methacrylate | | | | | | |
| | 2-(O-[1′-methylpropylideneamino]- | — | — | — | — | — | 10 |
| | carboxyamino)methacrylate | | | | | | |
| | Butyl acrylate | 10 | — | — | — | — | 10 |

| | | | | | | |
|---|---|---|---|---|---|---|
| Weight average molecular weight(Mw) | 700000 | 650000 | 690000 | 680000 | 680000 | 700000 |

### [Synthesis of Acrylic Resin]

Acrylic resin 2A to 2F used in Examples 2-1 to 2-8 were synthesized by a known solution polymerization method as follows.

### Synthesis Example of Acrylic Resin 2A

A 500 mL flask composed of a stirrer, a thermometer, a nitrogen gas introduction pipe, a discharge pipe and a heating jacket was used as a reaction container, 80 g of tetradecyl acrylate, 10 g of butyl acrylate, and 10 g of 2-[(3,5-dimethylpyrazolyl)carbonylamino]ethyl methacrylate as monomers, and 81.8 g of 2-propanol as a solvent were mixed, and the mixture was added to the reaction container, and stirred at room temperature (25° C.) and at a stirring rotational speed of 250 times/min for 1 hour, and nitrogen was flowed at 100 mL/min. Then, the temperature was raised to 70° C. over 30 minutes, and after temperature rise was completed, a solution obtained by dissolving 0.28 g of azobisisobutyronitrile in 2 mL of methyl ethyl ketone was added to the reaction container, and the reaction was started. Then, the mixture was stirred in the reaction container at a temperature of 70° C. and reacted for 5 hours. Then, a solution obtained by dissolving 0.05 g of azobisisobutyronitrile in 2 mL of methyl ethyl ketone was added to the reaction container, the temperature was raised to 90° C. for 15 minutes, and the mixture was additionally reacted for 2 hours. Then, the solvent was removed, dried to obtain an acrylic resin 2A. The weight average molecular weight (Mw) of the acrylic resin 2A was 31,000.

Acrylic resins 2B to 2F were synthesized in the same method as in the synthesis example of the acrylic resin 2A except that monomer components were changed to monomer components shown in Table 2. Table 2 also shows the weight average molecular weight (Mw) and the melting point of the obtained acrylic resins.

The melting point of the acrylic resin was measured as follows.

Using a differential scanning calorimeter (commercially available from PerkinElmer Co., Ltd., model number DSC8500), the temperature was raised to 100° C. at 20° C./min, and the acrylic resin was maintained at 100° C. for 3 minutes and then cooled to −30° C. at a rate of 10° C./min, and then maintained at −30° C. for 3 minutes. Then, the temperature raised again to 100° C. at a rate of 10° C./min, and thus thermal behavior of the acrylic resin was measured, and the melting peak was calculated as a melting point of the acrylic resin.

TABLE 2

| | | Acrylic resin | | | | | |
|---|---|---|---|---|---|---|---|
| | | 2A | 2B | 2C | 2D | 2E | 2F |
| Monomer | Lauryl acrylate | — | 93 | — | — | — | — |
| component | Tetradecyl acrylate | 80 | — | 93 | — | — | 80 |
| (parts by | Stearyl acrylate | — | — | — | 93 | — | — |
| mass) | Behenyl acrylate | — | — | — | — | 93 | — |
| | 2-[(3,5-Dimethylpyrazolyl)- | 10 | 7 | 7 | 7 | 7 | — |
| | carbonylamino]ethyl methacrylate | | | | | | |
| | 2-(O-[1′-methylpropylideneamino]- | — | — | — | — | — | 10 |
| | carboxyamino)methacrylate | | | | | | |
| | Butyl acrylate | 10 | — | — | — | — | 10 |

| | | | | | | |
|---|---|---|---|---|---|---|
| Weight average molecular weight (Mw) | 31000 | 29000 | 30000 | 29000 | 31000 | 41000 |
| Melting point (° C.) | 8.5 | −6.6 | 14.7 | 44.4 | 61.9 | 8.5 |

Here, lauryl acrylate (commercially available from Osaka Organic Chemical Industry Ltd.) tetradecyl acrylate (commercially available from Tokyo Chemical Industry Co., Ltd.) butyl acrylate (commercially available from Wako Pure Chemical Corporation), stearyl acrylate and behenyl acrylate (commercially available from NOF Corporation), 2-[(3,5-dimethylpyrazolyl)carbonylamino]ethyl methacrylate, and 2-(O-[1′-methylpropylideneamino]carboxyamino)methacrylate (commercially available from Showa Denko K.K.) were used.

### [Production of Heat Storage Material]

### Example 1-1

15 g of the acrylic resin 1A, 0.15 g of hexamethylenediamine as a curing agent, 0.015 g of dibutyltin dilaurate as a curing accelerator, and 20 g of methyl ethyl ketone as a solvent were mixed to adjust a resin composition. The resin composition was applied to a polyethylene terephthalate (PET) film, heated and dried at 80° C. for 30 minutes, and then cured at 150° C. for 5 minutes, and the PET film was removed to obtain a film-like heat storage material having a thickness of 100 μm.

### Examples 1-2 to 1-8

Heat storage materials were produced in the same method as in Example 1-1 except that the composition of the resin composition was changed as shown in Tables 3 and 4.

### Example 2-1

15 g of the acrylic resin 2A, 0.15 g of hexamethylenediamine as a curing agent, and 0.015 g of dibutyltin dilaurate as a curing accelerator were mixed to obtain a resin composition. The viscosity of the resin composition at 90° C. was measured using an E type viscometer (commercially available from Toki Sangyo Co., Ltd., PE-80L) based on JIS Z 8803. The results are shown in Tables 5 and 6.

Next, the resin composition was filled into a 10 cm×10 cmxl mm mold (SUS plate), and cured at 150° C. for 5 minutes to obtain a sheet-like heat storage material having a thickness of 1 mm.

### Examples 2-2 to 2-8

The viscosity of the resin composition was measured and the heat storage material was produced in the same method as in Example 2-1 except that the composition of the resin composition was changed as shown in Tables 5 and 6. The results are shown in Tables 5 and 6.

### [Evaluation of Melting Point and Amount of Heat Storage]

Each of the heat storage materials produced in the examples was measured using a differential scanning calorimeter (model number DSC8500 commercially available from PerkinElmer Co., Ltd.), and a melting point and an amount of heat storage were calculated. Specifically, the temperature raised to 100° C. at 20° C./min, the heat storage material was maintained at 100° C. for 3 minutes, and then cooled to −30° C. at a rate of 10° C./min, and then maintained at −30° C. for 3 minutes. Then, the temperature raised again to 100° C. at a rate of 10° C./min, and thus thermal behavior was measured. The melting peak was used as a melting point of the heat storage material, and the area was used as an amount of heat storage. The results are shown in Tables 3 to 6. Here, when the amount of heat storage was 30 J/g or more, it can be said that the amount of heat storage was excellent.

### [Evaluation of Liquid Leakage and Volatility]

The change in weight before and after each of the heat storage materials produced in the examples was left for 1,000 hours under an atmospheric atmosphere at a temperature of 80° C. was measured, and the weight loss ratio (%) was measured. The results are shown in Tables 3 to 6.

### [Heat Resistance Test (TG-DTA)]

The weight loss of each of the heat storage materials produced in the examples was measured using a thermogravimetric balance TG-DTA6300 (commercially available from Hitachi High-Tech Science Corporation). The temperature (° C.) at which the weight was reduced by 1% from the initial weight was read and used as a value of the 1% weight loss temperature. The results are shown in Tables 3 to 6.

### [Evaluation of Storage Stability]

Each of the resin compositions produced in the examples was filled into a 50 mL container, the container was sealed, and then put into a high-temperature and high-humidity oven at a temperature of 40° C. and a humidity of 60%, and the state after 3 months was observed. The non-gelled part was designated as A, and the gelled part was designated as B. The results are shown in Tables 3 to 6.

### [Measurement of Gelation Time]

1 g of each of the resin compositions produced in Examples 2-2 to 2-8 was filled into an aluminum cup having a diameter of 4 cm, and the aluminum cup was placed on a hot plate heated to 150° C. in advance, and the time until gelation was performed while stirring with a bamboo skewer was measured. The results are shown in Tables 5 and 6.

TABLE 3

| | | | Example | Example | Example | Example | Example | Example |
|---|---|---|---|---|---|---|---|---|
| | | | 1-1 | 1-2 | 1-3 | 1-4 | 1-5 | 1-6 |
| Composition | Acrylic | 1A | 15.0 | 15.0 | 15.0 | — | — | — |
| (parts by | resin | 1B | — | — | — | 15.0 | — | — |
| mass) | | 1C | — | — | — | — | 15.0 | — |
| | | 1D | — | — | — | — | — | 15.0 |
| | | 1E | — | — | — | — | — | — |
| | | 1F | — | — | — | — | — | — |
| | Curing | HMDA | 0.15 | — | — | 0.15 | 0.15 | 0.15 |
| | agent | DETA | — | 0.15 | — | — | — | — |
| | | Glycerin | — | — | 0.15 | — | — | — |
| | | L101 | 0.015 | 0.015 | 0.015 | 0.015 | 0.015 | 0.015 |

| | | | | | | |
|---|---|---|---|---|---|---|
| Melting point(° C.) | 8.4 | 6.8 | 6.5 | -6.2 | 12.7 | 44.0 |
| Amount of heat storage(J/g) | 44.3 | 40.2 | 41.2 | 35.0 | 50.2 | 79.0 |
| Liquid leakage and volatility (%) | <1 | <1 | <1 | <1 | <1 | <1 |
| Heat resistance (° C.) | 305 | 300 | 295 | 300 | 302 | 310 |
| Storage stability | A | A | A | A | A | A |

TABLE 4

| | | | Example1-7 | Example1-8 |
|---|---|---|---|---|
| Composition | Acrylic | 1A | — | — |
| (parts | resin | 1B | — | — |
| by mass) | | 1C | — | — |
| | | 1D | — | — |
| | | 1E | 15.0 | — |
| | | 1F | — | 15.0 |
| | Curing | HMDA | 0.15 | 0.15 |
| | agent | DETA | — | — |
| | | Glycerin | — | — |
| | | L101 | 0.015 | 0.015 |

| | | |
|---|---|---|
| Melting point (° C.) | 60.7 | 8.0 |
| Amount of heat storage(J/g) | 96.5 | 45.2 |
| Liquid leakage and volatility (%) | <1 | <1 |
| Heat resistance (° C.) | 315 | 312 |
| Storage stability | A | A |

TABLE 5

| | | | Example | Example | Example | Example | Example | Example |
|---|---|---|---|---|---|---|---|---|
| | | | 2-1 | 2-2 | 2-3 | 2-4 | 2-5 | 2-6 |
| Composition | Acrylic | 1A | 15.0 | 15.0 | 15.0 | — | — | — |
| (parts by | resin | 1B | — | — | — | 15.0 | — | — |
| mass) | | 1C | — | — | — | — | 15.0 | — |
| | | 1D | — | — | — | — | — | 15.0 |
| | | 1E | — | — | — | — | — | — |
| | | 1F | | — | — | — | — | — |
| | Curing | HMDA | 0.15 | — | — | 0.15 | 0.15 | 0.15 |
| | agent | DETA | — | 0.15 | — | — | — | — |
| | | Glycerin | — | — | 0.15 | — | — | — |
| | | L101 | 0.015 | 0.015 | 0.015 | 0.015 | 0.015 | 0.015 |

| | | | | | | |
|---|---|---|---|---|---|---|
| Viscosity (Pa · s) | 3.0 | 2.8 | 2.9 | 2.5 | 2.4 | 2.4 |
| Melting point (° C.) | 8.4 | 6.5 | 6.7 | −6.0 | 12.4 | 44.0 |
| Amount of heat storage (J/g) | 44.9 | 41.1 | 41.2 | 37.0 | 51.2 | 79.4 |
| Liquid leakage and volatility (%) | <1 | <1 | <1 | <1 | <1 | <1 |
| Heat resistance (° C.) | 300 | 296 | 290 | 298 | 300 | 305 |
| Storage stability | A | A | A | A | A | A |
| Gelation time (sec) | 20 | 30 | 140 | 35 | 40 | 38 |

TABLE 6

| | | | Example 2-7 | Example 2-8 |
|---|---|---|---|---|
| Composition | Acrylic | 1A | — | — |
| (parts | resin | 1B | — | — |
| by mass) | | 1C | — | — |
| | | 1D | — | — |
| | | 1E | 15.0 | — |
| | | 1F | — | 15.0 |
| | Curing | HMDA | 0.15 | 0.15 |
| | agent | DETA | — | — |
| | | Glycerin | — | — |
| | | L101 | 0.015 | 0.015 |

| | | |
|---|---|---|
| Viscosity (Pa · s) | 2.3 | 2.9 |
| Melting point (° C.) | 58.2 | 8.2 |
| Amount of heat storage (J/g) | 96.8 | 43.3 |
| Liquid leakage and volatility (%) | <1 | <1 |
| Heat resistance (° C.) | 301 | 312 |
| Storage stability | A | A |
| Gelation time (sec) | 35 | 22 |

In Tables 3 to 6, HMDA indicates hexamethylenediamine (commercially available from Wako Pure Chemical Corporation), DETA indicates diethylenetriamine (commercially available from Wako Pure Chemical Corporation), and L101 indicates dibutyltin dilaurate (commercially available from Tokyo Fine Chemical Co., Ltd.). Glycerin (commercially available from Wako Pure Chemical Corporation) was used.

The heat storage materials of the examples have an excellent amount of heat storage and also have excellent heat resistance, and can minimize liquid leakage and volatilization. In particular, since the heat storage materials of Examples 2-1 to 2-8 are obtained by curing the liquid resin composition, they are advantageous because they can also be applied to members having complicated shapes.

### REFERENCE SIGNS LIST

1 Article
2 Heat source
3 Heat storage material

1. A resin composition comprising an acrylic resin obtained by polymerizing a monomer component including a first monomer represented by the following Formula (1) and a second monomer copolymerizable with the first monomer and having a block isocyanate group: 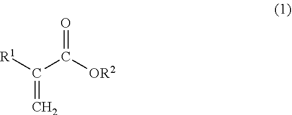
[in the formula, R¹ represents a hydrogen atom or a methyl group and R² represents an alkyl group having 12 to 30 carbon atoms].

2. A resin composition comprising an acrylic resin including a first structural unit represented by the following Formula (2) and a second structural unit having a block isocyanate group: 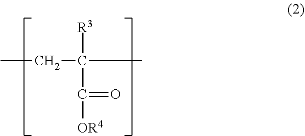
[in the formula, R³ represents a hydrogen atom or a methyl group, and R⁴ represents an alkyl group having 12 to 30 carbon atoms].

3. The resin composition according to claim 1, further comprising
a curing agent capable of reacting with the block isocyanate group under deprotection conditions of the block isocyanate group.

4. The resin composition according to claim 3, wherein the curing agent is at least one compound selected from the group consisting of an amine compound and an alcohol compound.

5. The resin composition according to claim 1, wherein a content of the first monomer is 60 parts by mass or more with respect to 100 parts by mass of the monomer components.

6. The resin composition according to claim 1, wherein a content of the second monomer is 25 parts by mass or less with respect to 100 parts by mass of the monomer components.

7. The resin composition according to claim 2, wherein a content of the first structural unit is 60 parts by mass or more with respect to 100 parts by mass of all structural units constituting the acrylic resin.

8. The resin composition according to claim 2, wherein a content of the second structural unit is 25 parts by mass or less with respect to 100 parts by mass of all structural units constituting the acrylic resin.

9. The resin composition according to claim 1, wherein a content of the acrylic resin is 50 parts by mass or more with respect to 100 parts by mass of the resin composition.

10. The resin composition according to claim 1, wherein the resin composition is used to form a heat storage material.

11. A heat storage material including a cured product of the resin composition according to claim 1.

12. An article, comprising:
a heat source; and
a cured product of the resin composition according to claim 1, the cured product provided to be in thermal contact with the heat source.
